(19) United States
(12) Patent Application Publication
(10) Pub. No.: US 2024/0308854 A1
(43) Pub. Date: Sep. 19, 2024

(54) Method for Making 3D-Shaped 3D Graphene

(71) Applicant: University of Cincinnati, Cincinnati, OH (US)

(72) Inventors: Vesselin N. Shanov, Cincinnati, OH (US); Vamsi Krishna Reddy Kondapalli, Cincinnati, OH (US)

(73) Assignee: University of Cincinnati, Cincinnati, OH (US)

(21) Appl. No.: 18/577,961

(22) PCT Filed: Jul. 11, 2022
(86) PCT No.: PCT/US22/36666

§ 371 Date: Jan. 9, 2024

Related U.S. Application Data
(60) Provisional application No. 63/220,189, filed on Jul. 9, 2021.

(51) Int. Cl. C01B 32/186

(52) U.S. Cl. CPC C01B 32/186; C01B 2204/22; C01B 2204/26; C01P 2002/01; C01P 2002/72; C01P 2004/03; C01P 2004/04; C01P 2006/40

(57) ABSTRACT

A novel method of making a 3D-shaped 3D graphene (3D²G) is disclosed. The method involves a) 3D printing a catalyst slurry via Direct Ink Writing (DIW); b) depositing the printed slurry using chemical vapor deposition (CVD) to produce a nickel-graphene composite; and c) etching the nickel-graphene composite. The resulting composite is a porous, binder-free structure of pure 3D²G. In one embodiment, the catalyst slurry comprises nickel particles mixed with an organic solvent, a polymer, and a plasticizer. In another embodiment, the organic solvent is dichloromethane, the polymer is poly lactic-co-glycolic acid and the plasticizer is dibutyl phthalate.

### CROSS REFERENCE TO RELATED APPLICATIONS

This application is a continuation of PCT Application No. PCT/US22/36666 filed Jul. 11, 2022, which claims benefit of U.S. Provisional Application Ser. No. 63/220,189, filed Jul. 9, 2021, which applications are hereby incorporated by reference in their entirety.

### TECHNICAL FIELD

The present invention relates to making three-dimensional shaped 3D graphene.

### BACKGROUND OF THE INVENTION

Graphene has revealed amazing properties and potential for multiple applications. However, this material is facing hurdles related to fabricating desired shapes and sizes, also limited scalability and handling. 3D Graphene (3DG) appeared to be a step ahead to overcome the limitations of its 2D atomic thin structures. Further improvement has been reported in scaling the 3D graphene, particularly 3D Graphene Sheet (3DGS) and 3D Shaped 3D Graphene (3D²G).

### SUMMARY OF THE INVENTION

In one embodiment, the present invention is a novel method of making a 3D-shaped 3D graphene (3D²G). The method involves a) 3D printing a catalyst slurry via Direct Ink Writing (DIW); b) depositing the printed slurry using chemical vapor deposition (CVD) to produce a nickel-graphene composite; and c) etching the nickel-graphene composite. The resulting composite is a porous, binder-free structure of pure 3D²G. In one embodiment, the catalyst slurry comprises nickel particles mixed with an organic solvent, a polymer, and a plasticizer. In another embodiment, the organic solvent is dichloromethane, the polymer is poly lactic-co-glycolic acid and the plasticizer is dibutyl phthalate. In one embodiment, the chemical vapor deposition involves heating the printed slurry in a gas mixture of hydrogen, argon, and a hydrocarbon to a temperature of at least 1000° C., followed by reducing the temperature at a rate of from about 20° C. to about 60° C. per minute until it reaches room temperature.

In another embodiment, a device is provided that incorporates 3D²G produced using the method described above. The device is selected from the group consisting of energy storage devices, thermoelectric devices, membranes for separation, fluid filters, gas sensors, pressure sensors and motion sensors.

In one embodiment, a method of making a compressed 3D shaped 3D graphene (C3D²G) is disclosed. The method involves compressing 3D²G prepared using the process described above, wherein the compression is accomplished using either rolling compression or static vertical compression to produce C3D²G. In another embodiment, the 3D²G is compressed using rolling compression at Room Temperature (RT). In one embodiment, the 3D2G is compressed using static vertical compression at Room Temperature (RT). In another embodiment, 3D²G comprises from about 1% to about 99% infill. In one embodiment, the 3D²G is compressed at an elevated temperature from about room temperature to about 500° C. in air or an inert environment. In another embodiment, the compression is accomplished by extruding the 3D²G through a nozzle to produce C3D²G. In one embodiment, the extrusion is conducted at room temperature.

In another embodiment, the extrusion is conducted at an elevated temperature from about room temperature to about 500° C. in air. In one embodiment, the 3D²G is co-extruded with a secondary material. In another embodiment, the secondary material is selected from the group consisting of metal, polymer, ceramic, paper, cellulose and combinations thereof; where the secondary material is used in bulk or fibrous form. In one embodiment, a product incorporating C3D²G prepared using the process described above is described. The product is selected from the group consisting of tubes, bars, and wires with a round or rectangular cross-section.

In another embodiment, a method of making composite materials is disclosed. The method involves compressing one or multiple layers of 3-Dimensional graphene (3DG) or 3D²G with another carbon-containing material, wherein the layers of graphene and material are laminated in a sandwich-like structure.

In one embodiment, the carbon-containing material is selected from the group consisting of Carbon Nanotube Sheet (CNTS), Carbon Veil, copper coated Carbon Veil, and nickel coated Carbon Veil. In another embodiment, the 3D²G is compressed using rolling compression at Room Temperature (RT). In one embodiment, the 3D²G is compressed using static vertical compression at Room Temperature (RT).

In one embodiment, the present invention is a method of making compressed 3D graphene (C3DG) and compressed 3D shaped, 3D graphene (C3D²G) where extrusion drives the densification of the materials causing improvement of their electrical, mechanical, and etch resistance properties.

In another embodiment, the present invention is a method of making compressed C3DG tubes, bars, and wires with round or rectangular cross-section by extrusion of 3DG through a nozzle at room temperature. In one embodiment, the extrusion is conducted at elevated temperatures from room temperature up to 500° C. in air.

In another embodiment, the present invention is a method of making composite tubes, bars, and wires with round or rectangular cross-section by co-extrusion of 3DG with a secondary material through a nozzle. In one embodiment, the secondary material is a metal in a bulk or fibrous form. In another embodiment, the secondary material is a polymer in a bulk on fibrous form. In one embodiment, the secondary material is a ceramic in a bulk or fibrous form. In another embodiment, the secondary material is paper or cellulose in a bulk or fibrous form.

In one embodiment, the present invention is a method of joining together two or multiple pieces of 3DG or 3D²G through rolling compression at RT causing welding between the fused parts.

In another embodiment, the compression temperature is between room temperature and 500° C. in air. In one embodiment, the present invention is a method of joining together two or multiple pieces of 3DG or 3D²G through static vertical compression at RT causing welding between the fused parts. In another embodiment, where the compression temperature is between room temperature and 500° C. in air.

In one embodiment, the present invention is a method of making composite materials by rolling compression at RT through laminating in a sandwich-like structure one or multiple layers of 3DG or 3D²G welded with one or multiple layers of Carbon Nanotube Sheet (CNTS).

In another embodiment, the present invention is a method of making composite materials by rolling compression at RT through laminating in a sandwich-like structure one or multiple layers of 3DG or 3D²G welded with one or multiple layers of Carbon Veil.

In one embodiment, the present invention is a method of making composite materials by rolling compression at RT through laminating in a sandwich-like structure one or multiple layers of 3DG or 3D²G welded with one or multiple layers of copper or nickel coated Carbon Veil. In another embodiment, the present invention is a method of making composite materials by static vertical compression at RT through laminating in a sandwich-like structure one or multiple layers of 3DG or 3D²G welded with one or multiple layers of Carbon Nanotube Sheet (CNTS).

In one embodiment, the present invention is a method of making composite materials by static vertical compression at RT through laminating in a sandwich-like structure one or multiple layers of 3DG or 3D²G welded with one or multiple layers of Carbon Veil. In another embodiment, the present invention is a method of making composite materials by static vertical compression at RT through laminating in a sandwich-like structure one or multiple layers of 3DG or 3D²G welded with one or multiple layers of copper or nickel coated Carbon Veil. In one embodiment, the compression temperature is between room temperature and 500° C. in air or in inert environment. In one embodiment, the present invention is a method of making composite materials by rolling compression at RT through laminating in a sandwich-like structure one or multiple layers of 3DG or 3D²G welded with one or multiple layers of paper sheet.

In another embodiment, the present invention is a method of making composite materials by rolling compression at RT through laminating in a sandwich-like structure one or multiple layers of 3DG or 3D²G welded with one or multiple layers of porous or non-porous polymer. In one embodiment, the present invention is a method of making composite materials by rolling compression at RT through laminating in a sandwich-like structure one or multiple layers of 3DG or 3D²G welded with one or multiple layers of fabric. In another embodiment, the present invention is a method of making composite materials by rolling compression at RT through laminating in a sandwich-like structure one or multiple layers of 3DG or 3D²G welded with one or multiple layers of porous or non-porous metal sheet. In one embodiment, the present invention is a method of making composite materials by static vertical compression at RT through laminating in a sandwich-like structure one or multiple layers of 3DG or 3D²G welded with one or multiple layers of paper sheet.

In another embodiment, the present invention is a method of making composite materials by static vertical compression at RT through laminating in a sandwich-like structure one or multiple layers of 3DG or 3D²G welded with one or multiple layers of porous or non-porous polymer.

In one embodiment, the present invention is a method of making composite materials by static vertical compression at RT through laminating in a sandwich-like structure one or multiple layers of 3DG or 3D²G welded with one or multiple layers of fabric. In another embodiment, the present invention is a method of making composite materials by static vertical compression at RT through laminating in a sandwich-like structure one or multiple layers of 3DG or 3D²G welded with one or multiple layers of porous or non-porous metal sheet.

In one embodiment, the compression temperature is between room temperature and 500° C. in air or in inert environment. In another embodiment, the present invention is a method of joining together two or multiple copper or nickel coated Carbon Veil pieces using 3DG or 3D²G as an adhesive glue via rolling compression at RT. In one embodiment, the present invention is a method of joining together two or multiple copper or nickel coated Carbon Veil pieces using 3DG or 3D²G as an adhesive glue via static vertical compression at RT. In another embodiment, the compression temperature is between room temperature and 500° C. in air.

In one embodiment, the present invention is a method of making hard protective masks of 3DG Sheets (3DGS) or 3D²G used in a Reactive Ion Etching (RIE) fluorine plasma environment for processing layered or bulk items, including films and substrates for microelectronics applications. In another embodiment, the present invention is a method of making hard protective masks of 3DGS or 3D²G used in RIE fluorine environments where the films or the substrates are made of single crystal silicon, polycrystalline silicon, metals, oxides, or other semiconductor materials. In another embodiment, adhering the patterned mask on the etched item, such as a silicon wafer, is achieved by wetting the mask with 0.5 ml per square centimeter of ethanol or acetone or isopropyl alcohol, followed by placing it on the item/wafer and mild heating the item/wafer with the mask for 15 minutes at 50-70° C. in ambient pressure to evaporate the solvent. In one embodiment, after completing the etching process, the hard mask is removed by wetting the same with 0.5 ml per square centimeter of ethanol or acetone or isopropyl alcohol, which deactivates the adhesion between the mask and the item/wafer. In another embodiment, after removing the hard mask from the item/wafer, the mask is ready for reuse by repeating the steps described herein.

In one embodiment, the present invention is a method of making hard protective masks made of C3DG used in a RIE fluorine environments where the C3DG is patterned by a Focused Ion Beam (FIB). In another embodiment, the C3DG is patterned by an Electron Beam (EB). In one embodiment, the patterning is achieved by 3D printing of a nickel-polymer slurry followed by CVD, acid removal of the residual nickel catalyst, and rolling compression at RT. In another embodiment, the patterning is achieved by 3D printing of the nickel-polymer slurry followed by CVD, acid removal of the residual nickel catalyst and static vertical compression at RT. In one embodiment, the compression temperature is between room temperature and 500° C. in air or in inert environment. In one embodiment, the present invention is a method of making hard coating or bulk material made of 3DG for protecting items exposed to RIE fluorine plasma environments.

### BRIEF DESCRIPTION OF THE DRAWINGS

The foregoing summary, as well as the following detailed description of preferred embodiments of the application, will be better understood when read in conjunction with the appended drawings.

FIG. 1A is an SEM image of pristine 3D²G.

FIG. 1B is a TEM image of pristine 3D²G.

FIG. 1C is the electron diffraction pattern of the pristine 3D²G.

FIG. 2A is a top view SEM image of compressed 3D graphene (C3D²G).

FIG. 2B is a cross-sectional SEM image of C3D²G.

FIG. 2C is a TEM image of C3D²G.

FIG. 2D is the electron diffraction pattern of C3D²G.

FIG. 3A is a SEM image of 3D²G with 30% infill before rolling compression. It shows low magnification of pristine 3D²G with a typical pattern of square pores and thickness of 500 μm.

FIG. 3B is a SEM image of the 3D²G of FIG. 3A at high magnification, revealing one square pore with well determined sides.

FIG. 3C is a SEM image of C3D²G with 30% infill after rolling compression. It shows low magnification of the compressed C3D²G, showing the entire pattern of the 3D printed square pores partly filled up with extruded 3D graphene and thickness of 15 μm.

FIG. 3D is a SEM image of the C3D²G of FIG. 3C at high magnification. It shows the deformed sides of one individual square pore due to partly extruded 3D graphene in it.

FIG. 4A is a SEM image of 3D²G with 40% infill before rolling compression. It shows low magnification of pristine 3D²G with a typical pattern of rectangular pores and thickness of 500 μm.

FIG. 4B is a SEM image of the 3D²G of FIG. 4A at high magnification, revealing one rectangular pore with well determined sides.

FIG. 4C is a SEM image of C3D²G with 40% infill after rolling compression. This low magnification image shows the entire pattern of the rectangular 3D printed pores filled up with extruded 3D graphene.

FIG. 4D is a SEM image of the C3D²G of FIG. 4C at high magnification. It shows one individual rectangular pore filled up with 3D graphene extruded in it.

FIG. 5A is an XRD spectrum of pristine 3D²G with a thickness of 500 μm.

FIG. 5B is an XRD spectrum of compressed C3D²G with a thickness of 15 μm.

FIG. 6 is a schematic showing compressive welding of two pieces of 3D²G.

FIG. 7A is a picture of two pieces of 3D2G welded together by cold rolling compression.

FIG. 7B is a picture of ten pieces of 3D2G welded together by cold rolling compression.

FIG. 8A is a graph showing the effect of welding overlap on electrical conductivity normalized by weight for two pieces of 3D²G joined together.

FIG. 8B is a graph showing the stress-strain curve obtained by tensile test for two pieces of 3D²G welded together by cold rolling compression, where the welded overlap is 0.5 cm.

FIG. 9A is a picture of a sandwich structure of welded composite consisted of 3D²G-copper coated carbon veil-3D²G.

FIG. 9B is a picture of a sandwich structure of welded composite consisted of 3D²G-CNT sheet-3D²G.

FIG. 9C is a picture of two copper coated pieces of carbon veil glued together using 3D²G as an adhesive glue via cold compressive welding.

FIG. 10A is a picture of a 30% infill C3D²G mask attached to a silicon wafer before etching.

FIG. 10B is a picture of a 30% infill C3D G mask on a silicon wafer after RIE for 2 minutes in 30 sccm CF4+Ar plasma using 100 W power.

FIG. 10C is a picture of the transferred etch pattern on the silicon wafer after the removal of the C3D²G mask.

FIG. 11 is a SEM image of C3D²G hard mask with 30% infill after RIE for 2 minutes in 30 sccm CF+2 sccm Ar plasma using 100 W power.

FIG. 12 is a graph showing the effect of infill density on the electrical properties of the 3D-shaped 3D graphene (3D²G).

FIG. 13 is a graph showing the effect of compression on the electrical conductivity of 30% infill 3D²G.

FIG. 14 is a graph showing the effect of infill density on the electrical conductivity of 30% and 40% infill 3D²G with 15 μm thickness.

### DETAILED DESCRIPTION

One skilled in the art will recognize that the various embodiments may be practiced without one or more of the specific details described herein, or with other replacement and/or additional methods, materials, or components. In other instances, well-known structures, materials, or operations are not shown or described in detail herein to avoid obscuring aspects of various embodiments of the invention. Similarly, for purposes of explanation, specific numbers, materials, and configurations are set forth herein in order to provide a thorough understanding of the invention. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but does not denote that they are present in every embodiment. Thus, the appearances of the phrases “in an embodiment” or “in another embodiment” in various places throughout this specification are not necessarily referring to the same embodiment of the invention. Further, “a component” may be representative of one or more components and, thus, may be used herein to mean “at least one.”

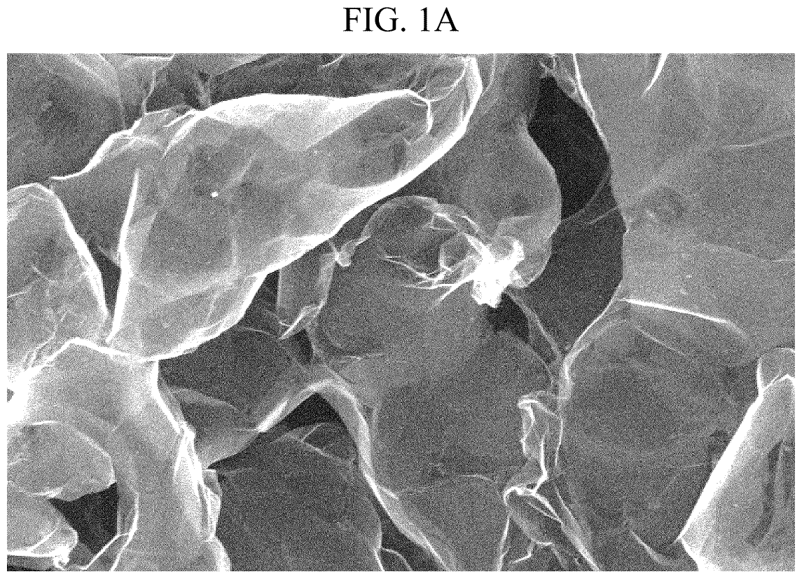

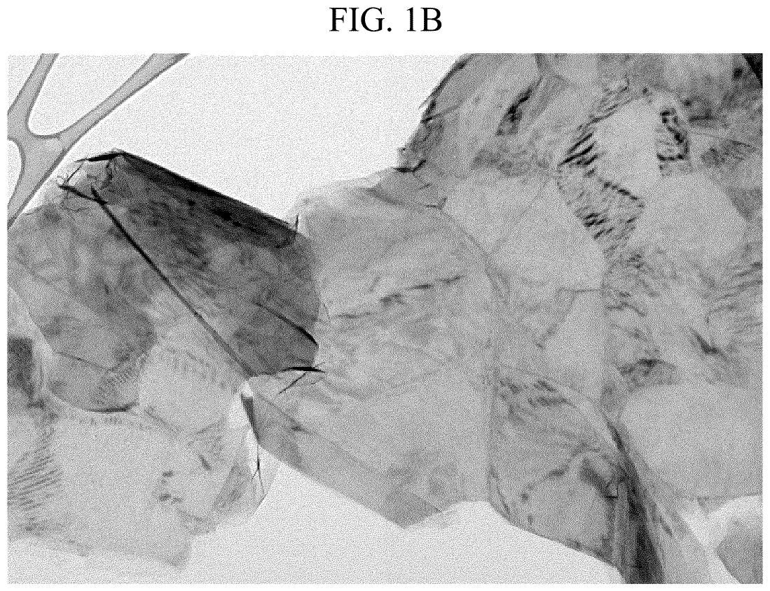

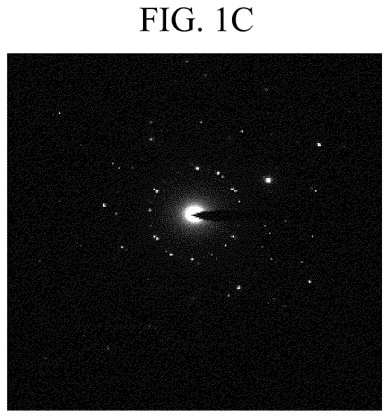

As used herein, “3D graphene” means a structure of multi-layer graphene flakes with different spatial orientation and interconnected within the 3D space thus building a 3D structure, as displayed in FIGS. 1A and 1B.

In one embodiment, the present invention involves a method to synthesize a 3D-shaped 3D graphene (3D²G) with good quality, desirable shape, and structure control by combining 3D printing with a Chemical Vapor Deposition (CVD) process. In one embodiment, Direct Ink Writing (DIW) is used in this invention as a 3D printing technique to print a nickel powder-poly lactic-co-glycolic acid (PLGA) slurry into various shapes. This slurry is used as catalysts for graphene growth via CVD. Porous 3D²G with high purity was obtained after etching out the nickel substrate. In another embodiment, the design for the 3D printed catalyst slurry is acquired via an industrial 3D scanner which after scanning the object, creates a CAD file, or a picture, or G Code used to control the 3D printer.

A Scanning Electron Microscopy (SEM) and 2D Raman study of pristine and compressed 3D²G was conducted for the present invention. This study revealed important features about the internal structure of this new material, with proof that it differs from the regular graphene particularly after significant compression. The interconnected porous nature of the obtained 3D²G combined with its good electrical conductivity (about 17 S/cm) and promising electrochemical properties invites applications for energy storage electrodes, where fast electron transfer and intimate contact with the active material and with the electrolyte are critically important. In one embodiment, the present invention demonstrates that by changing the printing design, one can manipulate the electrical, electrochemical, and mechanical properties of the graphene, including the porosity, without any additional doping or chemical post-processing. The obtained binder-free 3D²G showed a very good thermal stability, tested by Thermo-Gravimetric Analysis (TGA) in the air up to 500° C.

The present invention takes the novel approach of bringing together two advanced manufacturing approaches, CVD and 3D printing, thus enabling the synthesis of high-quality, binder-free 3D graphene structures with a tailored design that are suitable for multiple applications. In another embodiment, a method for making 3D shaped 3D graphene (3D²G) using 3D printing of the catalyst, combined with CVD is disclosed. In one embodiment, the present invention involves a method for making 3D shaped 3D graphene (3D²G) using 3D printing of the catalyst, combined with CVD, where the catalyst is a slurry of Ni particles mixed with a polymer and a plasticizer. In another embodiment, the slurry does not comprise graphene. In one embodiment, the slurry does not comprise a carbon source. In another embodiment, the present invention involves a method for making 3D²G using 3D printing of the catalyst, combined with CVD, where the catalyst is a slurry of Cu particles or combination of Cu+Ni particles mixed with a polymer, a plasticizer, and a solvent. In one embodiment, the present invention involves a method for making 3D²G using 3D printing of the catalyst, combined with CVD, where the size of the Ni particles is between 0.1 micron and 100 microns with preference of 3-7 microns.

In another embodiment, the present invention involves a method for making 3D²G using 3D printing of the catalyst, combined with CVD, where the polymer is poly lactic-co-glycolic acid (PLGA). In one embodiment, the present invention involves a method for making 3D²G using 3D printing of the catalyst, combined with CVD, where the plasticizer is Dibutyl Phthalate (DBP).

In another embodiment, the present invention involves a method for making 3D²G using 3D printing of the catalyst, combined with CVD, where the slurry is prepared by mixing of nickel powder with DBP along with dichloromethane, and adding to this mixture PLGA dissolved in DBP followed by sonication of the resulted slurry. In one embodiment, the present invention involves a method for making 3D²G using 3D printing of the catalyst, combined with CVD, where the viscosity of the Ni slurry is in the range of from about 1 to about 50 Pa·s. In one embodiment, the viscosity is about 10 Pa·s. This is adjusted by evaporating or adding Dichloromethane (DCM). In another embodiment, the present invention involves a method for making 3D²G using 3D printing of the catalyst, combined with CVD, where Direct Ink Writing (DIW) of the slurry is applied using a 3D bio printer.

In one embodiment, the present invention involves a method for making 3D²G using 3D printing of the catalyst, combined with CVD, where Ni-PLGA structures are 3D printed at pressures ranging from 48 kPa to 117 kPa using various stainless steel blunt needles with internal diameters ranging from 250 μm to 430 μm at a printing speed of 2 mm/s to 15 mm/s. In another embodiment, the present invention involves a method for making 3D²G using 3D printing of the catalyst, combined with CVD, where a CVD process is employed to treat the obtained structures by the 3D printing process. In one embodiment, the present invention involves a method for making 3D²G using 3D printing of the catalyst, combined with CVD, where the CVD process is conducted in the presence of a gas mixture consisted of hydrogen, argon and hydrocarbon such as methane, at a temperature of 1000° C., followed by a rapid decrease of the temperature with a cooling speed of from about 20 to about 60° C. per minute. In one embodiment, the cooling speed is about 40° C. per minute.

In another embodiment, the present invention involves a method for making 3D²G using 3D printing of the catalyst, combined with CVD, where the obtained by the CVD nickel-graphene composite is treated with Ni-dissolving etchants, such as HCl acid H₂SO₄ acid or a mixture of both, to remove the remaining Ni catalyst thus producing a binder-free 3D graphene of high purity. In one embodiment, the present invention involves a method for making 3D²G using 3D printing of the catalyst, combined with CVD, where the synthesized 3D graphene is exposed to a compressive load on it for tailoring and enhance the mechanical and electrical properties of the 3D graphene. In another embodiment, the present invention involves a method for making 3D²G using 3D printing of the catalyst, combined with CVD, where the compressive load is applied using a rolling press where the sample is placed between 2 stainless steel sheets, and the gap between the rollers of the rolling press controlling the load is in the range of 0.1 to 0.5 mm, preferably 0.125 mm. In one embodiment, the present invention involves a method for making 3D²G using 3D printing of the catalyst, combined with CVD, where the made 3D graphene is processed by a focused laser beam to create cross-sections by cutting with open pores and increased surface area. In another embodiment, the present invention involves a method for making 3D²G using 3D printing of the catalyst, combined with CVD, where the applications of the made 3D graphene include, but are not limited, to energy storage devices (electrodes for supercapacitors and batteries), thermoelectric devices, membranes for separation, filters for fluids (air, water, etc.), and sensors sensing gases, pressure, motion, etc.

In one embodiment of the present invention, a method of etching a pattern on a substrate is provided. The method involves placing a patterned mask on the substrate, etching the substrate by Reactive Ion Etching in a fluorine plasma environment, and removing the patterned mask from the substrate. The patterned mask comprises C3D²G made by compressing 3D²G. Further, the compression is accomplished using either rolling compression or static vertical compression to produce C3D²G. In another embodiment, the substrate comprises a material selected from the group consisting of silicon, metal, ceramic, and combinations thereof.

### Compressed 3-Dimensional Graphene

One embodiment of the present invention involves a method of compacting 3-dimensional graphene (3DG) and/or 3D shaped 3D graphene (3D²G) materials by rolling compression or static vertical compression. This can be done at room temperature. The resulting products have new structures formed via extrusion with improved mechanical, electrical and etch resistance properties. Alternatively, the compression can be conducted at elevated temperatures (from about room temperature to about 500° C.) in air or in an inert environment. The present invention can be used to make tubes, bars, and wires of compressed 3DG (C3DG) by extrusion at room or elevated temperatures. This can be done by extruding 3DG through a nozzle with the desired shape and size. Further, adding a secondary material along with 3DG such as metal, polymer, ceramic, or paper, will result in forming composite items containing C3DG produced via extrusion.

In another embodiment of the present invention, a method of joining together multiple pieces of 3DG sheet (3DGS) and 3D²G through cold or hot rolling compression or static vertical compression is provided. The compression causes welding between the fused parts. The same process of welding can be used for making composite materials by cold or hot rolling compression or static vertical compression causing lamination of 3DG and 3D²G with multiple porous sheet-like materials such as metalized or pristine carbon veil, carbon nanotube sheet, paper, polymer, fabric, and metal. The 3DGS and 3D²G are an effective glue for joining together different materials via cold and hot rolling or static vertical compression. Another embodiment involves methods of making hard protective masks of C3DG and compressed 3D²G (C3D²G), and their use in Reactive Ion Etching (RIE) fluorine plasma environments.

In some embodiments, the 3DGS and 3D²G of the present invention are synthesized on sintered nickel catalyst via Chemical Vapor Deposition (CVD), resulting in a microstructure that is like that of a polycrystalline metal where the graphene flakes resemble metal grains arranged in random directions. This is not the case for graphite, which has perfect and repeating A-B staking of the graphene layers within its structure. A high-resolution Scanning Electron Microscopy (SEM) image of pristine 3D Shaped 3D Graphene (3D²G) revealing various graphene flakes randomly joined together within the 3D space along with distinguished materials' pores, is shown in FIG. 1A. The TEM image in FIG. 1B confirms this notion where a grained structure is revealed with clearly noticed boundaries between the graphene flakes. FIG. 1C displays the related electron diffraction pattern which suggests diffraction through a few graphene flakes with different orientation and number of layers in them.

The porous nature of 3DGS and 3D²G structure welcomes applications in areas like energy storage and gas sensors. However, other applications including Electromagnetic Interference (EMI) shielding and thermoelectric energy conversion, or electric power transmission require high electrical conductivity, which cannot be achieved without further processing. The present invention has found that electrical conductivity can be altered by changing the materials' porosity via rolling compression. In addition, structural porosity in 3D²G can be changed by tailoring the design of the 3D printed bulk. Without being bound by theory, the shortening of electron transfer paths through this material via suppression of porosity appears to be the reason for the observed increase in the electrical conductivity.

The 3D printed structure of 3D graphene can be made with different percentages of infill, which determines the structural porosity of the obtained bulk. Here, 3D printed infill represents the “fullness” of the inside of a part. In slicers, this is usually defined as a percentage between 0 and 100, with 0% making a part hollow and 100%, completely solid. Thus, the lesser the infill, the larger the structural pores are in the 3D printed graphene.

The higher the infill percentage is, the more 3DG is employed in the final 3D²G structure, which results in less structural porosity. Samples consisting of four layer 3D printed Ni-polymer slurry have been converted by CVD and acid etching into 3D²G with 30% and 40% infill. The obtained 3D²G specimens were further compressed between two stainless steel shims at room temperature using an MTI Hot Rolling Press, (Model MSK-HRP-01) with 0.125 mm gap between the rollers. This processing resulted in obtaining samples with 15 μm thickness which are named here as “Compressed 3D²G” or C3D²G. During the process of compression, the graphene flakes, which are initially randomly oriented, are aligned with simple cold rolling. The structures obtained in this way reveal enhanced electrical and mechanical properties along with offering an opportunity to join or weld separate pieces of 3DG, thus forming bigger specimens.

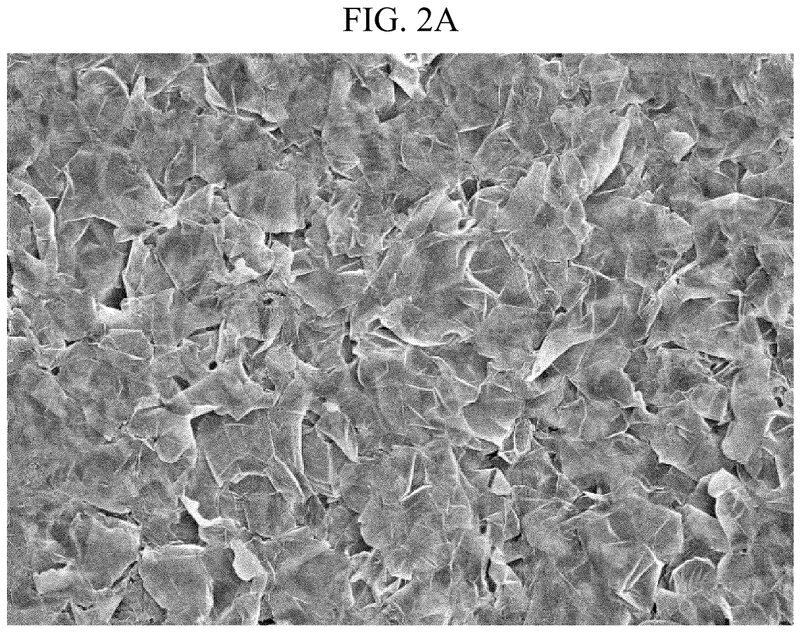

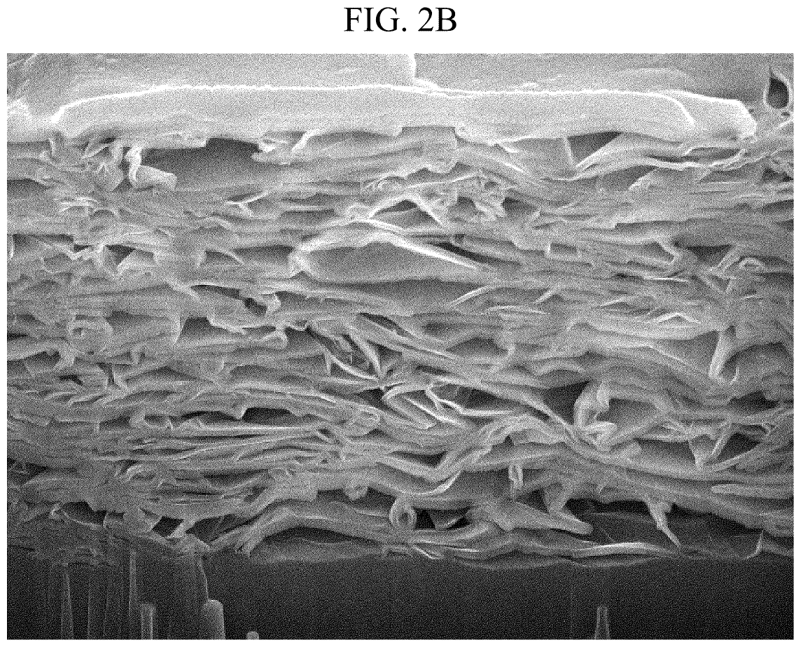

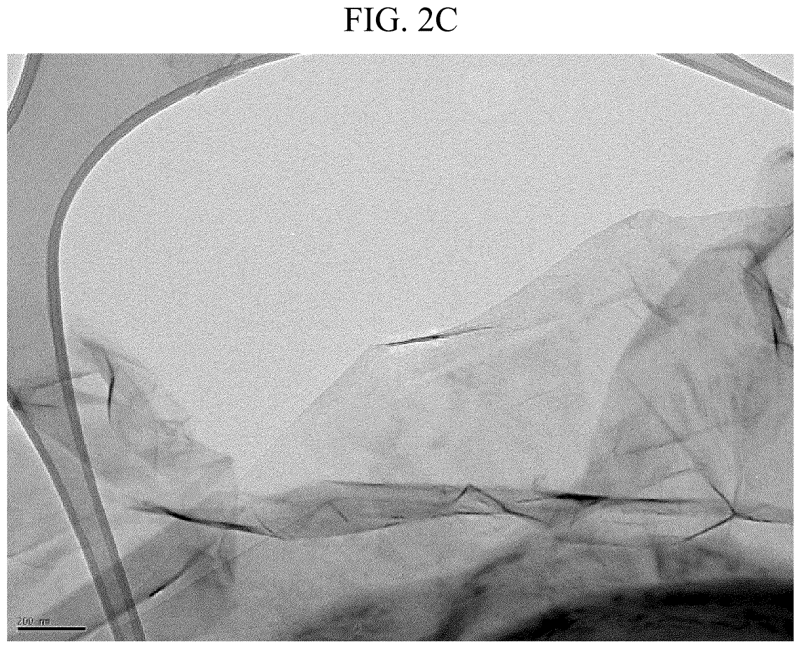

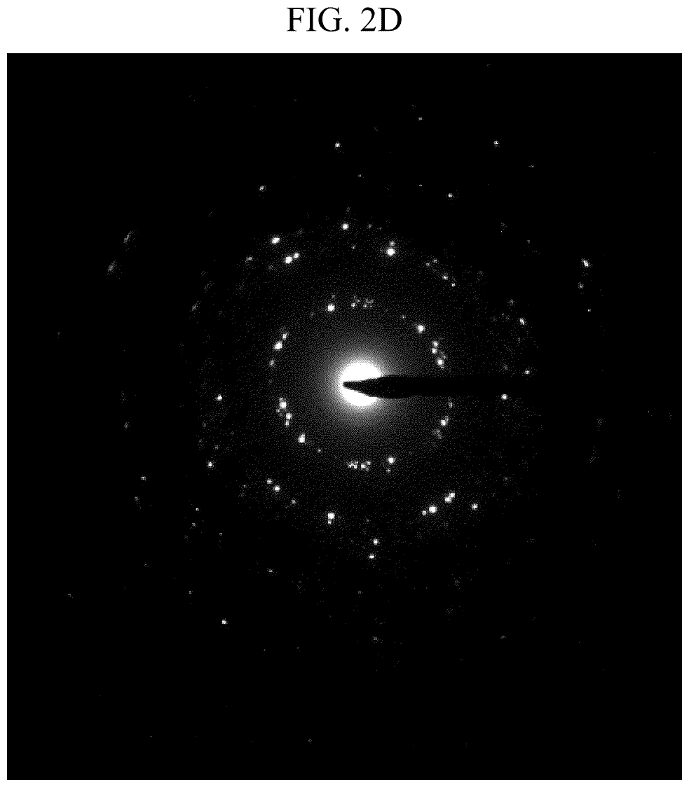

A scanning electron microscopy study was performed to understand the effect of compression on the microstructure of 3DG. High resolution SEM image (top view) of the C3D²G surface taken after applying rolling compression, is displayed in FIG. 2A. The surface morphology of the flattened sample differs from that of pristine 3D²G shown in FIG. 1A. The randomly oriented graphene flakes seem partly collapsed. The cross-sectional SEM image of the C3D²G cut by a Focused Ion Beam (FIB) revealed the changes within the structure of this material. Such an image is shown in FIG. 2B and illustrates the alignment of the graphene flakes stacked upon each other after rolling compression. The TEM image of the compressed sample in FIG. 2C does not reveal the grained structure observed in the pristine graphene. This appearance may be because the collapsed flakes under compression and their partial alignment on top of each other form a “stack-like” structure. However, the individual flakes may be rotated towards each other along with layer's rotation in every flake, thus deviating from the typical for the graphite A-B stacking. This notion is supported by the electron diffraction pattern of C3D²G shown in FIG. 2D. As seen there, the pattern forms circles with different radii suggesting diffraction from many flakes with different orientations within the stack like in a textured polycrystalline structure.

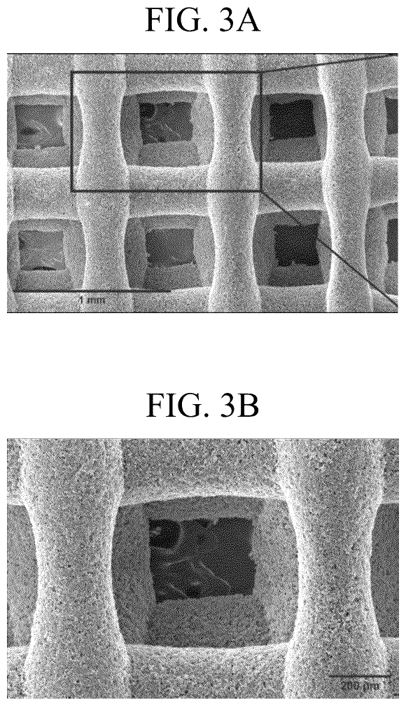

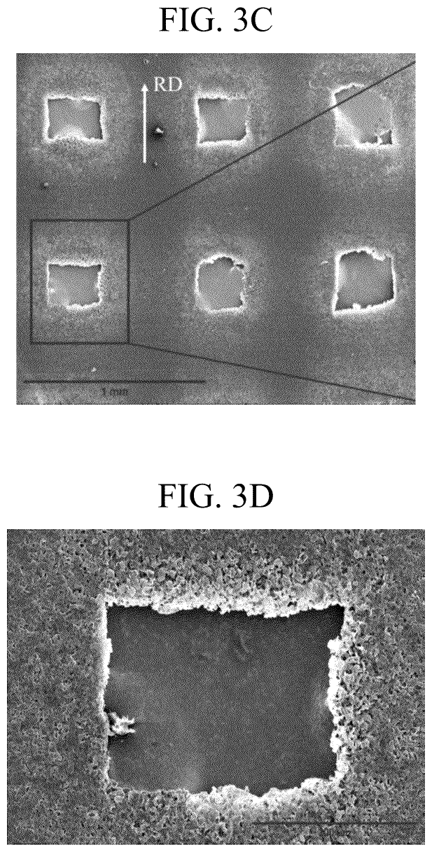

Unlike other graphene materials, 3D²G does not fail or break under compression. Rather, it shows “creep-like” behavior and extrudes in a similar fashion as a polycrystalline metal where grains become aligned due to directional cold rolling. FIGS. 3A-D and 4A-D present SEM images of C3D²G with 30% and 40% infill before and after rolling compression. The rectangular openings seen within the images are the structural pores created via 3D printing of the Ni-polymer prior to CVD. FIGS. 3A-3D show SEM images taken at 2 magnifications of 3D²G with 30% infill before and after rolling compression. The low magnification image of pristine 3D²G with a thickness of 500 μm shows a typical pattern of square pores (FIG. 3A). High magnification of 3D²G exposes one square pore with well determined sides (FIG. 3B). Low magnification of compressed C3D²G shows the entire pattern of the 3D printed square pores partly filled up with extruded 3D graphene decreasing the sample thickness to 15 μm (FIG. 3C). The high magnification of C3D²G image indicates that near the shown individual structural pore the sides of the square are deformed and irregular in the rolling direction (RD) due to partly extruded 3D graphene in it (FIG. 3D).

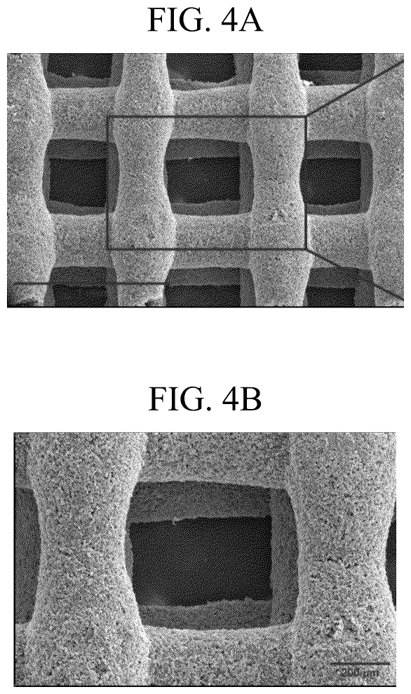

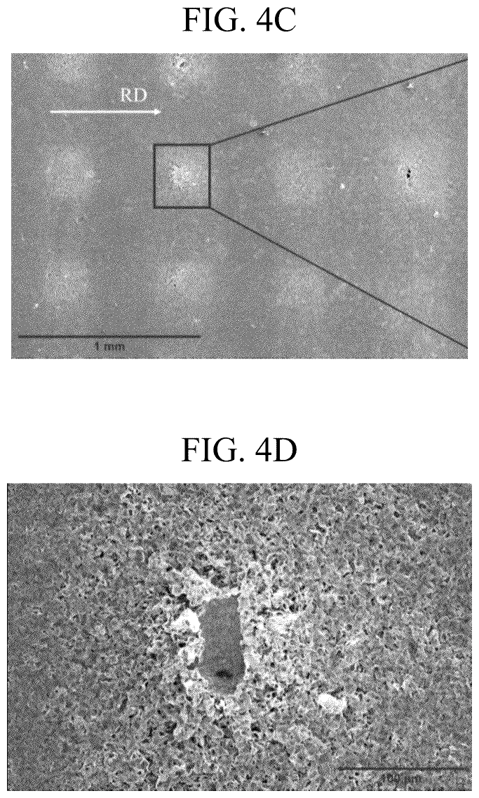

FIGS. 4A-4D exhibit SEM images taken at 2 magnifications of 3D²G with 30% infill before and after rolling compression. The low magnification image of pristine 3D²G with thickness of 500 μm displays a typical pattern of rectangular pores (FIG. 4A). The high magnification of 3D²G reveals one rectangular pore with well determined sides (FIG. 4B). The low magnification of compressed C3D²G displays the entire pattern of the 3D printed rectangular pores partly filled up with extruded 3D graphene and reduced sample thickness of 15 μm (FIG. 4C). At high magnification of C3D²G it is noticed that the shown individual rectangular pore there is filled up with 3D graphene extruded in it (FIG. 4D).

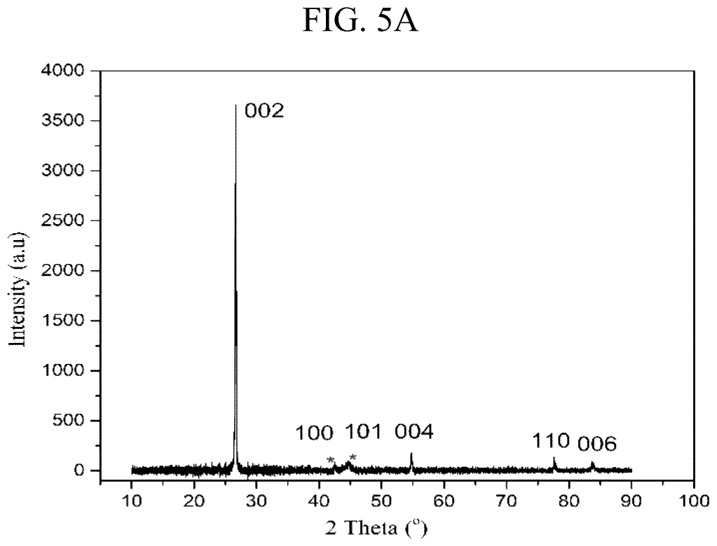

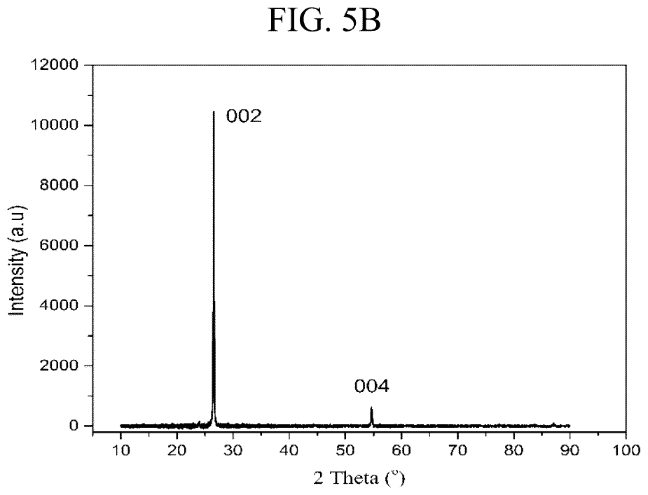

The performed SEM study revealed for the first time a new phenomenon for 3D graphene claimed here and called extrusion, which is typical for many polymers and metal exposed to elevated pressure and temperatures. We believe that in the 3D²G material subjected to rolling compression, micro-motion of graphene flakes takes place resulting a new collapsed and layered structure. This observation was further supported by the conducted X-Ray Diffraction (XRD) study. FIG. 5A displays XRD spectrum of pristine 3D²G with thickness of 500 μm, where multiple peaks are observed along with the main 002 one, due to the randomly arranged graphene flakes. However, in the spectrum of the compressed sample shown in FIG. 5B, most of the peaks are suppressed except for 002 and 004. This suggests a strong alignment along 002 and 004 directions and formation of textured structure which enhances the mechanical, thermal, and electrical properties of the C3D²G samples.

### EXAMPLES

### Example 1: Welding of 3DG Via Compression

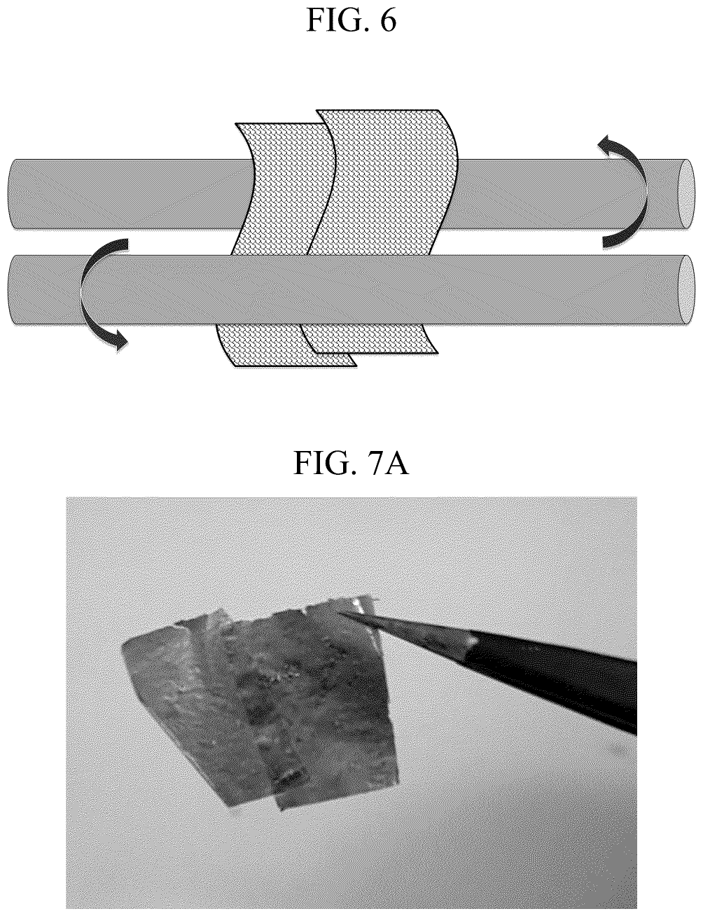

Based on the discovered property (extrusion) of 3D²G under stress, various possibilities to weld pieces of 3DGS or 3D²G via rolling compression were explored. This approach offered an opportunity to make samples with large area and dimensions by combining multiple smaller pieces. The schematic shown in FIG. 6 illustrates how two 3D²G pieces partly overlapping each other can be processed via cold rolling compression, which can result in their welding within the overlapped area.

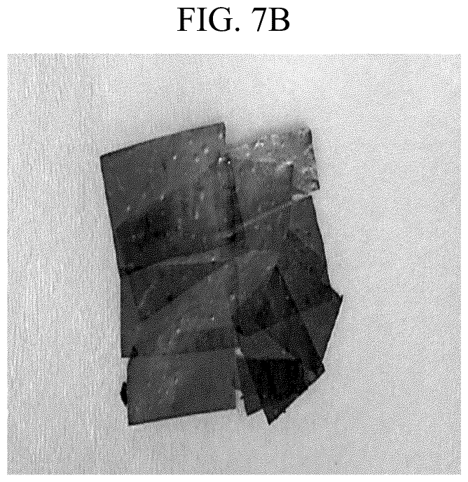

The welding was possible only due to the extrusion of graphene from one 3D²G piece to the other. FIGS. 7A and 7B show pictures of welded 3D²G by cold rolling compression. Particularly, two pieces have been joined together and displayed in FIG. 7A, while FIG. 7B shows ten pieces joined together. In both cases the samples for welding have been prepared by 3D printing and CVD of one printed layer 3D²G. This welding process successfully addresses the scalability of 3D graphene by combining multiple pieces together in a large sample via compressive joining.

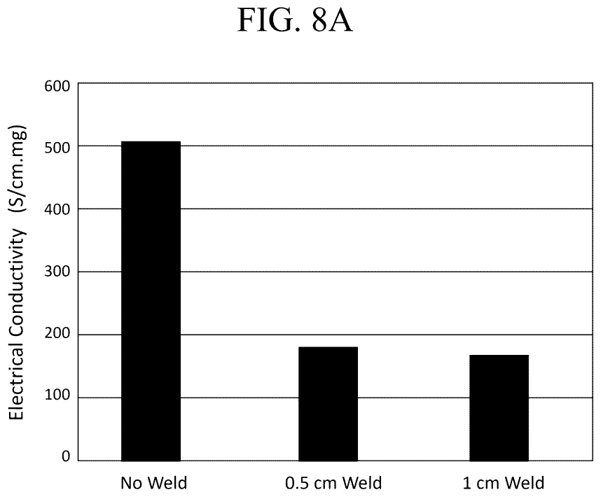

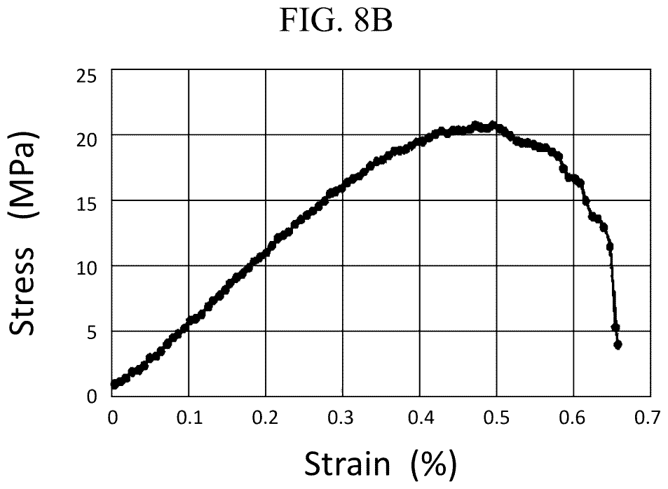

The electrical conductivity measurements of the welded samples can help understand the type of bonding within the welded region. FIG. 8A shows a comparison of electrical conductivity for samples with different welded overlap lengths. We believe that the observed decrease in conductivity with increasing the welded overlap area suggests that the bond between the 2 welded pieces does not have a chemical nature, rather is a mechanical bond achieved via extrusion of graphene. Seems that the joined area has an increase in resistance compared to a sample with no-welding regions. Thus, extrusion seems to be the only reason behind the observed welding.

A stress-strain curve was obtained by tensile test of two pieces 3D²G welded together, where the welded overlap was 0.5 cm, is displayed in FIG. 8B. The tested rectangular samples in this experiment were with dimensions of 5 mm×44 mm, and welded overlap of 5 mm and 10 mm respectively. It was observed that irrespective of the welded area, the samples always failed outside the welded region highlighting higher strength of the joint, which exceeded that of the C3D²G itself. Despite that the bond in the welded region does not have a chemical nature, it was proved to be very strong. This finding supports the claim for successful scalability via welding in fabricating 3D graphene samples with large area and increased dimensions.

### Example 2: Composite Materials Based on 3D Graphene, CNT Sheet, and Cu-Coated Carbon Veil Made by Compressive Welding

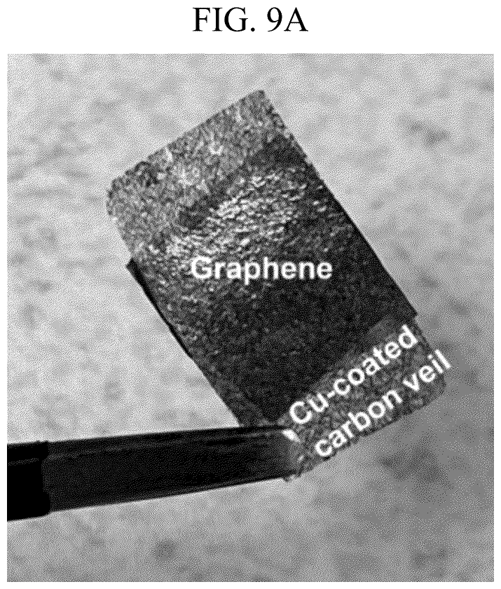

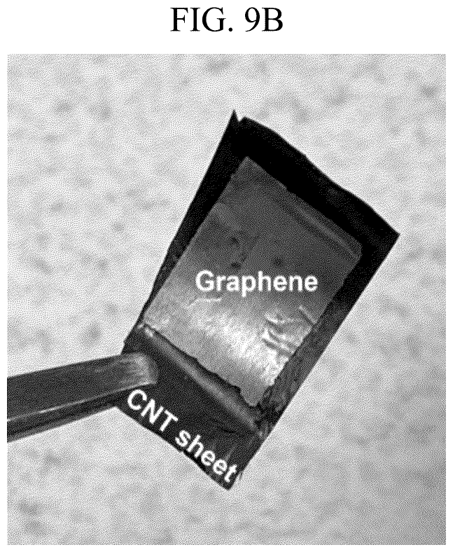

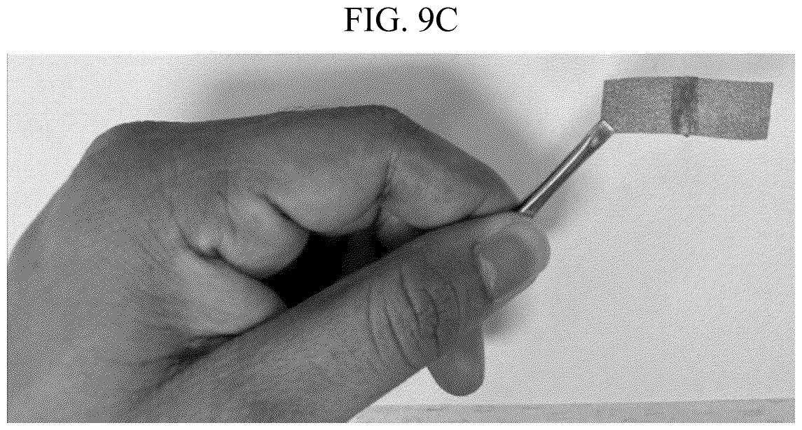

The extrusion phenomenon observed in 3D²G during cold compression can further enable the manufacturing of composites where the 3D²G can act as both a primary functional material or as a glue for joining two or more pieces of functional materials. This approach works with various micro and nano porous material including Carbon Nanotube sheet (CNT sheet), carbon veil, copper coated carbon veil, and variety of fabrics. In one embodiment of the present invention, these materials can be sandwiched between two 3D²G pieces and compressed together via a rolling press. In one embodiment, the gap between the rollers is about 0.15 mm. FIGS. 9A-9C show pictures of composite materials made by cold compressive welding. Sandwich structures of welded composites consisted of 3D²G-copper coated carbon veil-3D²G, and of 3D²G-CNT sheet-3D²G, are displayed in FIGS. 9A and 9B, respectively. Another picture of two copper coated pieces of carbon veil glued together using graphene as an adhesive via cold compressive welding, is exhibited in FIG. 9C. The created composites were obtained only via cold rolling without any further post processing.

### Example 3: Compressed 3D Graphene as a Hard Protective Mask for Reactive Ion Etching (RIE)

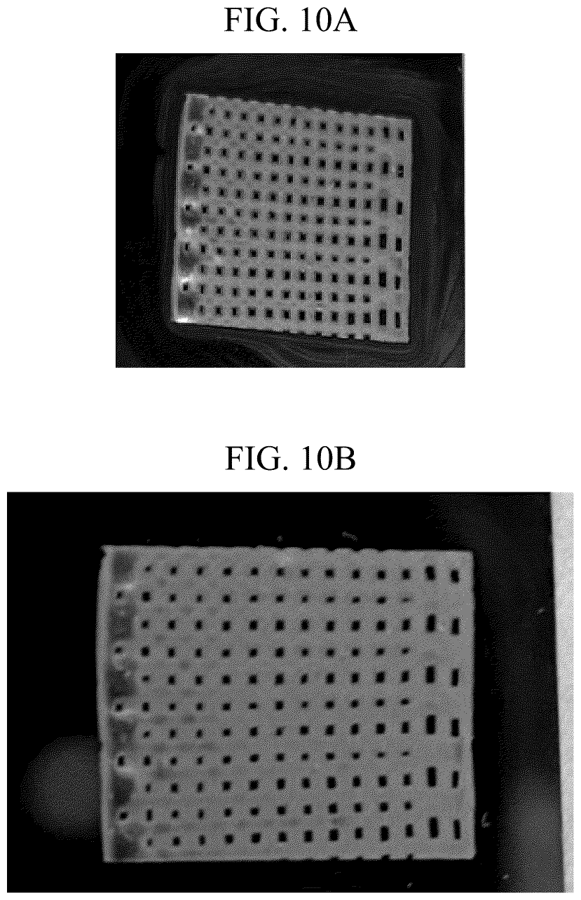

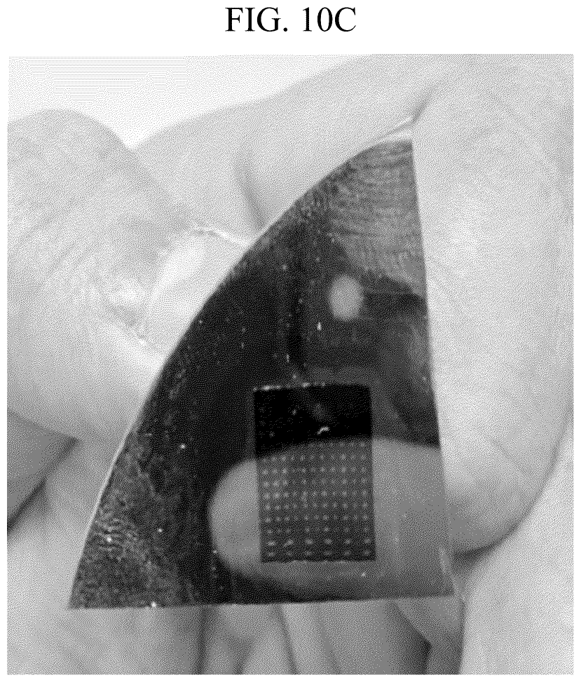

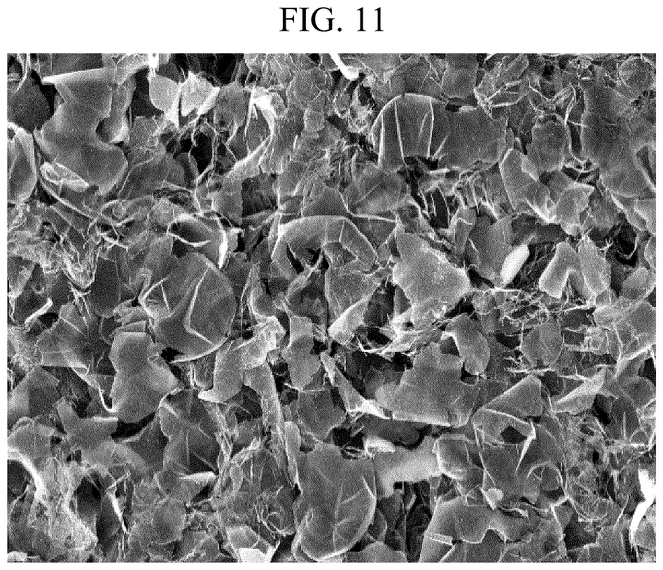

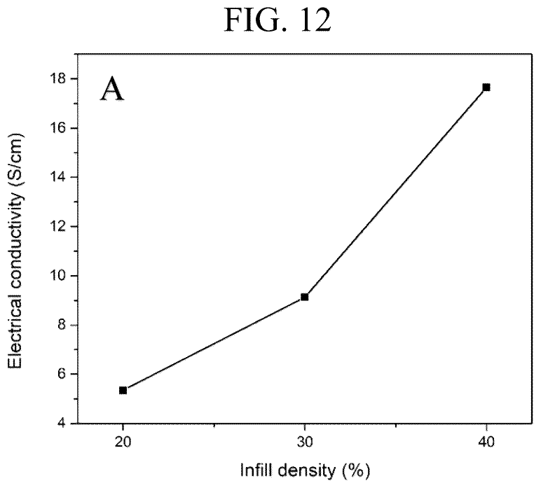

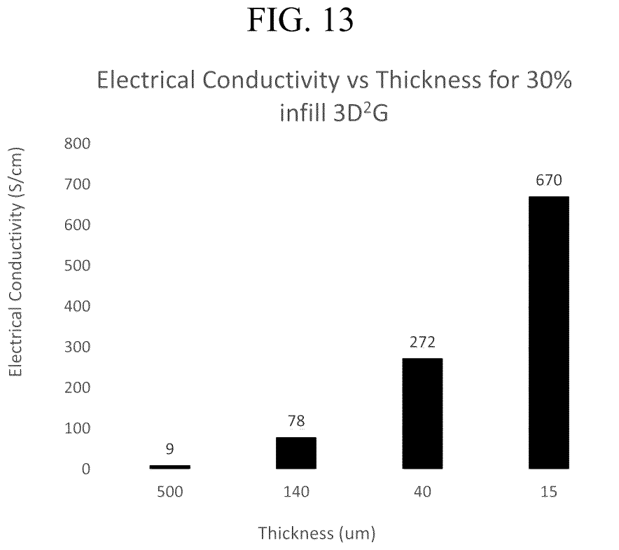

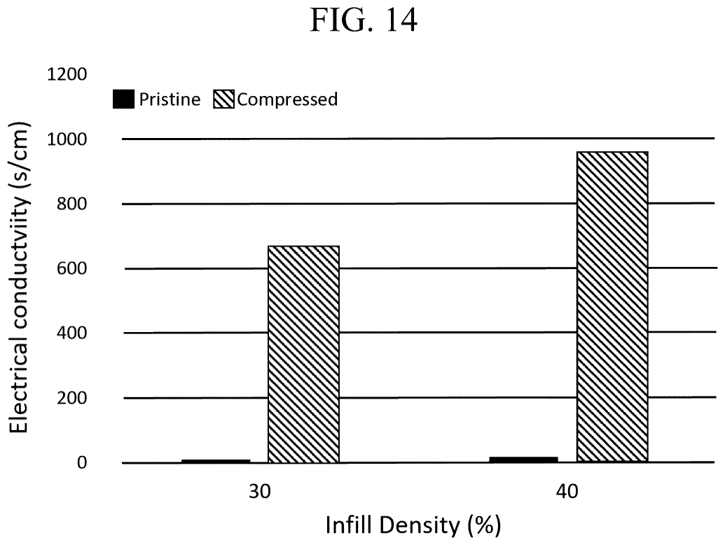

Compressing of 3D graphene reduces the numbers of pores which also collapse when exposed to pressure. This processing increases the gravimetric density of the material from 0.03 g/cm³ for pristine 3DG to 1.12 g/cm³ for compressed 3DG. The compressed sample value is close to the density of amorphous carbon (1.2 g/cm³), which has been used as a hard mask for semiconductor processing. In one embodiment, the present invention uses compressed 3D²G as an alternative material for making hard mask to transfer patterns on silicon wafers when they are exposed to Reactive Ion Etching (RIE). The present invention additionally involves a similar application of compressed 3D graphene as a protective coating for various parts inside plasma chambers exposed to fluorine (CF4) plasma environment during different semiconductor processing. In one embodiment, the following steps are used in employing C3D²G as a hard mask for RIE:
a. Synthesis of 3D²G with required pattern by 3D printing of Ni-polymer slurry, followed by CVD and acid removal of the residual Ni catalyst, as per the procedure mentioned above.
b. Cold rolling of 3D²G to the required thickness according to the procedure described above.
c. Placing the patterned C3D²G mask on a silicon wafer and wetting it with a few drops of ethanol or acetone or isopropyl alcohol, then heating the wafer with the mask for 15 minutes at 50-70° C. in ambient pressure to evaporate the solvent. The evaporation of the solvent causes the C3D²G mask to adhere greatly on the surface of the wafer due to capillary action. Picture of the resultant structure, where the C3D²G hard mask with 30% infill is firmly attached to the wafer, is shown in FIG. 10A.
d. Etching of the silicon wafer through the mask by Reactive Ion Etching in a fluorine plasma environment with selected plasma power, working pressure, gas composition and time.
e. Removing the hard mask after etching by wetting it with a couple of drops of ethanol or acetone or isopropyl alcohol which deactivates the adhesion between the mask and the wafer. After drying the removed C3D²G mask is ready for reuse by repeating the steps described above. A picture of the C3D²G mask with 30% infill on the silicon wafer after RIE for 2 minutes in 30 sccm CF4+Ar plasma using 100 W power, is shown in FIG. 10B. As it can be seen there, the C3D²G mask has not experienced any damage or change during the RIE. The transferred etch pattern on the silicon wafer after the removal of the C3D²G mask can be observed in FIG. 10C.

### Example 4

A SEM image of C3D²G hard mask with 40% infill after RIE for 2 minutes in 30 sccm CF₄+2 sccm Ar plasma using 100 W power, is displayed in FIG. 11. The observed surface morphology showed signs of minor material removal, but no substantial change compared to non-etched mask. The profile of the etched silicon wafer after removal of the C3D²G mask was obtained by a profilometer. The profile revealed uniformly etched pockets within the silicon wafer having depth of 112 nm.

### Example 5

Determining the etch rate of C3D²G is important to evaluate the performance of the mask in fluorine plasma environment. Etch rates of polycrystalline silicon, C3D²G, 3D²G, and graphite have been experimentally studied using different etch time and etch power. These four materials, shaped as rectangular coupons, were mounted on glass slides, placed simultaneously in the RIE chamber, and etched at the same time. Etch rates were measured by tracking the change of samples' weight and further normalized by area and etch time. The etch rates of various materials exposed for 2 minutes to 30 sccm CF₄+2 sccm Ar plasma using 100 W power were determined. The data there reveal a very low etch rate of C3D²G when compared to 3D²G, graphite, and polycrystalline silicon. Particularly, the etch rates of 3D²G, graphite, and silicon are 1.57, 2.95 and 29.8 times the etch rate of C3D²G respectively. On the other hand, when the etching was conducted with power of 300 W for both 2 minutes and 4 minutes, the results changed slightly compared to the case of 100 W. The etch rates of 3D²G, graphite, and silicon are 1.78, 1.4 and 13.6 times the etch rate of C3D²G respectively. Thus, the C3D²G of the present invention displays an extraordinary etch resistance, which makes this material a competitive candidate for hard mask used in fluorine RIE environment and in general for etch resistant protection.

TABLE 1
Comparison of the etch resistance of compressed 3D²G at various plasma etching parameters
with other common materials used in the semiconductor processing industry.

| | Plasma Power | | | | | |
|---|---|---|---|---|---|---|
| | 300 W | | | | 100 W | |
| | Etch Rate | | Total Etch | | Etch Rate | Total Etch |
| | (mg/mm2 · s) | | (mg/mm2) | | (mg/mm2 · s) | (mg/mm2) |
| Material | 2 Mins | 4 mins | 2 mins | 4 mins | 2 mins | |
| Compressed | 2.40040E−06 | 2.50371E−06 | 2.88048E−04 | 6.00890E−04 | 2.31666E−07 | 2.78000E−05 |
| 3D²G | | | | | | |
| Pristine 3D²G | 4.29086E−06 | 4.22168E−06 | 5.04854E−04 | 1.01320E−03 | 3.64533E−07 | 4.37439E−05 |
| Graphite | 3.38061E−06 | 3.39040E−06 | 4.05673E−04 | 8.37697E−04 | 6.84393E−07 | 8.21271E−05 |
| Silicon | 3.13710E−05 | 3.07782E−05 | 3.76452E−03 | 7.38676E−03 | 6.91024E−06 | 8.29228E−04 |

All documents cited are incorporated herein by reference; the citation of any document is not to be construed as an admission that it is prior art with respect to the present invention. It is to be further understood that where descriptions of various embodiments use the term “comprising,” and/or “including” those skilled in the art would understand that in some specific instances, an embodiment can be alternatively described using language “consisting essentially of” or “consisting of.”

While particular embodiments of the present invention have been illustrated and described, it would be obvious to one skilled in the art that various other changes and modifications can be made without departing from the spirit and scope of the invention. It is therefore intended to cover in the appended claims all such changes and modifications that are within the scope of this invention.

What is claimed is:

1. A method of making a 3D-shaped 3D graphene (3D²G) comprising:
a. 3D printing a catalyst slurry via Direct Ink Writing (DIW);
b. depositing the printed slurry using chemical vapor deposition (CVD) to produce a nickel-graphene composite;
c. etching the nickel-graphene composite, wherein the resulting composite is a porous, binder-free structure of 3D²G.

2. The method of claim 1, wherein the catalyst slurry comprises nickel particles mixed with an organic solvent, a polymer, and a plasticizer.

3. The method of claim 2 wherein the organic solvent is dichloromethane, the polymer is poly lactic-co-glycolic acid and the plasticizer is dibutyl phthalate.

4. The method of claim 1, wherein the chemical vapor deposition comprises heating the printed slurry in a gas mixture of hydrogen, argon, and a hydrocarbon to a temperature of at least 1000° C., followed by reducing the temperature at a rate of from about 20° C. to about 60° C. per minute until it reaches room temperature.

5. A device comprising 3D²G produced using the method of claim 1 wherein the device is selected from the group consisting of energy storage devices, thermoelectric devices, membranes for separation, fluid filters, gas sensors, pressure sensors and motion sensors.

6. A method of making a compressed 3D shaped 3D graphene (C3D²G) comprising compressing 3D²G prepared using the process of claim 1, wherein the compression is accomplished using either rolling compression or static vertical compression to produce C3D²G.

7. The method of claim 6 wherein the 3D²G is compressed using rolling compression at Room Temperature (RT).

8. The method of claim 6 wherein the 3D²G is compressed using static vertical compression at Room Temperature (RT).

9. The method of claim 6 wherein t sample infill is between 1% and 99%.

10. The method of claim 6 wherein the 3D²G is compressed at an elevated temperature from about room temperature to about 500° C. in air or an inert environment.

11. A method of making a compressed 3D shaped 3D graphene (C3D²G) comprising compressing 3D²G prepared using the process of claim 1, wherein the compression is accomplished by extruding the 3D²G through a nozzle to produce C3D²G.

12. The method of claim 11 wherein the extrusion is conducted at room temperature.

13. The method of claim 11 wherein the extrusion is conducted at an elevated temperature from about room temperature to about 500° C. in air.

14. The method of claim 11 wherein the 3D²G is co-extruded with a secondary material.

15. The method of claim 11 wherein the secondary material is selected from the group consisting of metal, polymer, ceramic, paper, cellulose and combinations thereof; where the secondary material is used in bulk or fibrous form.

16. A product comprising C3D²G prepared using the process of claim 11 wherein the product is selected from the group consisting of tubes, bars, and wires with a round or rectangular cross-section.

17. A method of making composite materials by compressing one or multiple layers of 3 Dimensional graphene (3DG) or 3D²G with another carbon-containing material, wherein the layers of graphene and material are laminated in a sandwich-like structure.

18. The method of claim 17 wherein the carbon-containing material is selected from the group consisting of Carbon Nanotube Sheet (CNTS), Carbon Veil, copper coated Carbon Veil, and nickel coated Carbon Veil.

19. The method of claim 17 wherein the 3D²G is compressed using rolling compression at Room Temperature (RT).

20. The method of claim 17 wherein the 3D²G is compressed using static vertical compression at Room Temperature (RT).

21. A method of making a fused piece of 3DG or 3D²G comprising compressing multiple pieces of 3DG or 3D²G simultaneously, wherein the compression is accomplished using either rolling compression or static vertical compression to produce a single fused piece.

22. The method of claim 21 wherein the 3DG or 3D²G is compressed using rolling compression at Room Temperature (RT).

23. The method of claim 21 wherein the 3DG or 3D²G is compressed using static vertical compression at Room Temperature (RT).

24. The method of claim 21 wherein the 3DG or 3D²G is compressed using rolling compression at a temperature from greater than room temperature to about 500° C. in air.

25. The method of claim 21 wherein the 3DG or 3D²G is compressed using static vertical compression at a temperature from greater than room temperature to about 500° C. in air.

26. A method of etching a pattern on a substrate comprising:
a. placing a patterned mask on the substrate;
b. etching the substrate by Reactive Ion Etching in a fluorine plasma environment; and
c. removing the patterned mask from the substrate;
wherein the patterned mask comprises C3D²G made by compressing 3D²G prepared using the process of claim 1, wherein the compression is accomplished using either rolling compression or static vertical compression to produce C3D²G.

27. The method of claim 26 wherein the substrate comprises a material selected from the group consisting of silicon, metal, ceramic, and combinations thereof.
